(19) United States
(12) Patent Application Publication
(10) Pub. No.: US 2025/0061265 A1
(43) Pub. Date: Feb. 20, 2025

(54) INFORMATION PROCESSING APPARATUS, LAYOUT ASSISTANCE METHOD, AND RECORDING MEDIUM

(71) Applicant: NEC Corporation, Minato-ku, Tokyo (JP)

(72) Inventors: Ichiro IGURA, Tokyo (JP); Naoki KATOH, Tokyo (JP); Takahiro TOIZUMI, Tokyo (JP); Akiyuki ISHIYAMA, Tokyo (JP); Yasuhiko AWASAWA, Tokyo (JP)

(73) Assignee: NEC Corporation, Minato-ku, Tokyo (JP)

(21) Appl. No.: 18/722,134

(22) PCT Filed: Dec. 24, 2021
(86) PCT No.: PCT/JP2021/048077

§ 371 Date: Jun. 20, 2024

(51) Int. Cl. G06F 40/106; G06F 3/0482; G06F 3/0483

(52) U.S. Cl. CPC G06F 40/106; G06F 3/0482; G06F 3/0483

(57) ABSTRACT

In order to easily select a candidate from among layout candidates, the candidate conforming with the intention of a user, an information processing apparatus (1) includes: a display control section (11) for displaying, on a display, (i) a list of articles to be arranged in a layout and (ii) pieces of layout information in each of which an arrangement of the articles in a corresponding one of candidates for the layout is represented with use of respective shapes corresponding to the articles, the list and the pieces of layout information being displayed such that the shapes are associated with the articles in the list; and an accepting section (12) for accepting a selection made by a user with respect to the candidates.

### TECHNICAL FIELD

An example aspect of the present invention relates to an information processing apparatus, etc. for assisting generation of a layout in which to arrange articles on a page of a newspaper, a magazine, or the like and on a web page.

### Background Art

The work of arranging articles in a layout on a page of a newspaper, a magazine, or the like has been performed manually, and there has been a demand for a technique for saving the work and increasing the efficiency of the work. Examples of such a technique include the layout generation system disclosed in Patent Literature 1 below.

With this layout generation system, a server acquires contents such as an image and text which are elements to be arranged in a layout of a page of a document, and generates the image of the layout in which the contents are arranged on the page of the document. This enables a user of the layout generation system of Patent Literature 1 to obtain, simply by inputting elements to be arranged in a layout, a layout image in which the elements are arranged on a page of a document.

### CITATION LIST

### Patent Literature

[Patent Literature 1]

Japanese Patent Application Publication Tokukai No. 2021-51595

### SUMMARY OF INVENTION

### Technical Problem

The layout generation system disclosed in Patent Literature 1 is susceptible of improvement from the viewpoint of easily selecting a candidate from among candidates for a layout, the candidate conforming with the intention of a user. Specifically, with the layout generation system disclosed in Patent Literature 1, among pieces of layout information generated by a server, pieces of layout information having scores which are ranked high are outputted to a terminal and imported to text editing software. With this configuration, a user of the terminal needs to check individual pieces of layout information imported, to select layout information which matches contents intended to be arranged in a layout. However, Patent Literature 1 does not provide any disclosure of a configuration for making this selection easier.

An example aspect of the present invention has been made in view of the above problem, and an example object thereof is to provide a technique for easily selecting a candidate from among candidates for a layout, the candidate conforming with the intention of a user.

### Solution to Problem

An information processing apparatus in accordance with an example aspect of the present invention includes: a display control means for displaying, on a display, (i) a list of articles to be arranged in a layout and (ii) pieces of layout information in each of which an arrangement of the articles in a corresponding one of candidates for the layout in which to arrange the articles is represented with use of respective shapes corresponding to the articles, the list and the pieces of layout information being displayed such that each of the shapes in the pieces of layout information is associated with an article in the list which corresponds to that shape; and an accepting means for accepting a selection made by a user with respect to the candidates.

A layout assistance method in accordance with an example aspect of the present invention includes: at least one processor displaying, on a display, (i) a list of articles to be arranged in a layout and (ii) pieces of layout information in each of which an arrangement of the articles in a corresponding one of candidates for the layout in which to arrange the articles is represented with use of respective shapes corresponding to the articles, the list and the pieces of layout information being displayed such that each of the shapes in the pieces of layout information is associated with an article in the list which corresponds to that shape; and the at least one processor accepting a selection made by a user with respect to the candidates.

A layout assistance program in accordance with an example aspect of the present invention causes a computer to function as: a display control means for displaying, on a display, (i) a list of articles to be arranged in a layout and (ii) pieces of layout information in each of which an arrangement of the articles in a corresponding one of candidates for the layout in which to arrange the articles is represented with use of respective shapes corresponding to the articles, the list and the pieces of layout information being displayed such that each of the shapes in the pieces of layout information is associated with an article in the list which corresponds to that shape; and an accepting means for accepting a selection made by a user with respect to the candidates.

### Advantageous Effects of Invention

According to an example aspect of the present invention, it is possible to easily select a candidate from among candidates for a layout, the candidate conforming with the intention of a user.

### BRIEF DESCRIPTION OF DRAWINGS

FIG. 1 is a block diagram illustrating a configuration of an information processing apparatus in accordance with a first example embodiment of the present invention.

FIG. 2 is a flowchart illustrating a flow of a layout assistance method in accordance with the first example embodiment of the present invention.

FIG. 3 is a block diagram illustrating a configuration of an information processing apparatus in accordance with a second example embodiment of the present invention. FIG. 4 is a diagram illustrating an example of a display screen displayed for a user to select a layout.

FIG. 5 is a diagram illustrating an example of pieces of layout information regarding candidates generated by a plurality of methods.

FIG. 6 is a diagram illustrating an example of layout information which contains information indicating a result of a local layout.

FIG. 7 is a diagram illustrating layout information which contains importance information.

FIG. 8 is a diagram illustrating an example of a display screen on which degrees of importance are indicated in the list of articles.

FIG. 9 is a flowchart illustrating a flow of a layout assistance method in accordance with the second example embodiment of the present invention.

FIG. 10 is a diagram illustrating an example of a computer which carries out instructions of a program which is software for implementing the functions of each of the apparatuses in accordance with the example embodiments of the present invention.

### EXAMPLE EMBODIMENTS

### First Example Embodiment

The following description will discuss a first example embodiment of the present invention in detail, with reference to the drawings. The present example embodiment is basic to example embodiments which will be described later.

### (Configuration of Information Processing Apparatus)

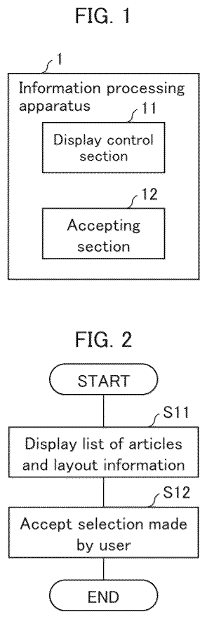

The configuration of an information processing apparatus 1 in accordance with the present example embodiment will be described below, with reference to FIG. 1. FIG. 1 is a block diagram illustrating a configuration of the information processing apparatus 1. The information processing apparatus 1 includes a display control section (display control means) 11 and an accepting section (accepting means) 12, as illustrated in FIG. 1.

The display control section 11 displays, on a display, (i) a list of articles to be arranged in a layout and (ii) pieces of layout information in each of which an arrangement of the articles in a corresponding one of candidates for the layout in which to arrange the articles is represented with use of respective shapes corresponding to the articles. In the displaying, the display control section 11 displays a shape in the layout information and an article of the list which corresponds to the shape such that the shape is associated with the article. The accepting section 12 then accepts a selection made by a user with respect to the candidates for the layout for the articles.

As above, a configuration in which a display control section 11 and an accepting section 12 are included is adopted in the information processing apparatus 1 in accordance with the present example embodiment, the display control section 11 displaying, on a display, (i) a list of articles to be arranged in a layout and (ii) pieces of layout information in each of which an arrangement of the articles in a corresponding one of candidates for the layout in which to arrange the articles is represented with use of respective shapes corresponding to the articles, the list and the pieces of layout information being displayed such that each of the shapes in the layout information is associated with an article in the list which corresponds to that shape, the accepting section 12 accepting a selection made by a user with respect to the candidates.

With this configuration, layout information is displayed in which the arrangement of articles is indicated with use of respective shapes corresponding to the articles. This makes it possible for a user to easily imagine the layout of each candidate. In addition, with this configuration, a shape in the layout information and an article in the list which corresponds to the shape are displayed such that the shape is associated with the article. This makes it possible for a user to easily recognize articles in the list which correspond to respective shapes in the layout information. Thus, this configuration provides an example advantage of being capable of easily selecting a candidate from among candidates for a layout, the candidate conforming with the intention of a user.

The generation of the candidates for a layout and the generation of the layout information may be carried out by the information processing apparatus 1, or may be carried out by another apparatus. For example, after causing a cloud server to generate the candidates for a layout and generate the layout information, the information processing apparatus 1 may display the generated layout information as described above and accept a selection made by a user.

### (Assistance Program)

The above function of the information processing apparatus 1 can be implemented by a program. An assistance program in accordance with the present example embodiment causes a computer to function as: a display control means for displaying, on a display, (i) a list of articles to be arranged in a layout and (ii) pieces of layout information in each of which an arrangement of the articles in a corresponding one of candidates for the layout in which to arrange the articles is represented with use of respective shapes corresponding to the articles, the list and the pieces of layout information being displayed such that each of the shapes in the layout information is associated with an article in the list which corresponds to that shape; and an accepting means for accepting a selection made by a user with respect to the candidates. This assistance program provides an example advantage of being capable of easily selecting a candidate from among the candidates for a layout, the candidate conforming with the intention of a user.

### (Flow of Layout Assistance Method)

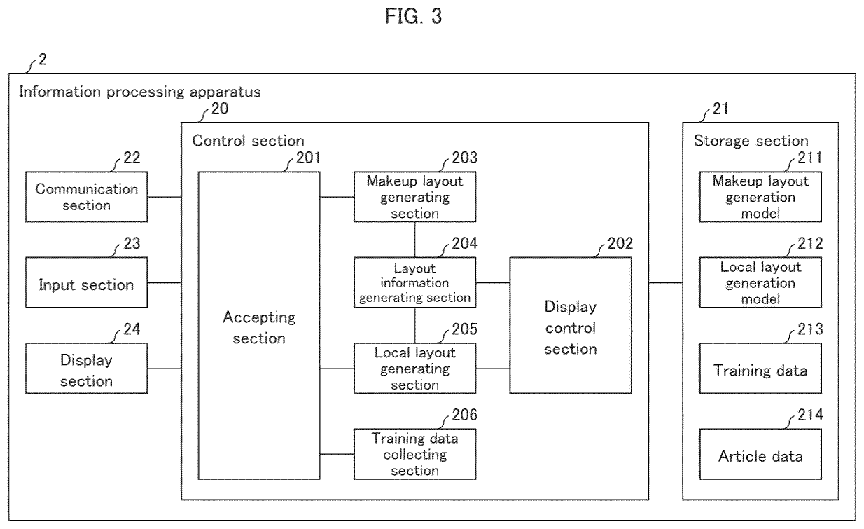

Here is a flow of a layout assistance method in accordance with the present example embodiment, provided with reference to FIG. 2. FIG. 2 is a flowchart illustrating a flow of the layout assistance method. Each of the steps of this assistance method may be carried out by a processor included in the information processing apparatus 1 or a processor included in another apparatus. Alternatively, the steps may be carried out by respective processors provided in different apparatuses.

In S11, at least one processor displays (i) a list of articles to be arranged in a layout and (ii) pieces of layout information in each of which an arrangement of the articles in a corresponding one of candidates for the layout in which to arrange the articles is represented with use of respective shapes corresponding to the articles. In the displaying, the at least one processor displays a shape in the layout information and an article in the list which corresponds to the shape such that the shape is associated with the article.

In S12, the at least one processor accepts a selection made by a user with respect to the candidates.

As described above, the layout assistance method in accordance with the present example embodiment includes at least one processor displaying, on a display, (i) a list of articles to be arranged in a layout and (ii) pieces of layout information in each of which an arrangement of the articles in a corresponding one of candidates for the layout in which to arrange the articles is represented with use of respective shapes corresponding to the articles, the list and the pieces of layout information being displayed such that each of the shapes in the layout information is associated with an article of the articles in the list which corresponds to that shape (S11); and the at least one processor accepting a selection made by a user with respect to the candidates (S12). With this assistance method, it is possible to easily select a candidate from among the candidates for a layout, the candidate conforming with the intention of a user.

### Second Example Embodiment

### (Configuration of Information Processing Apparatus)

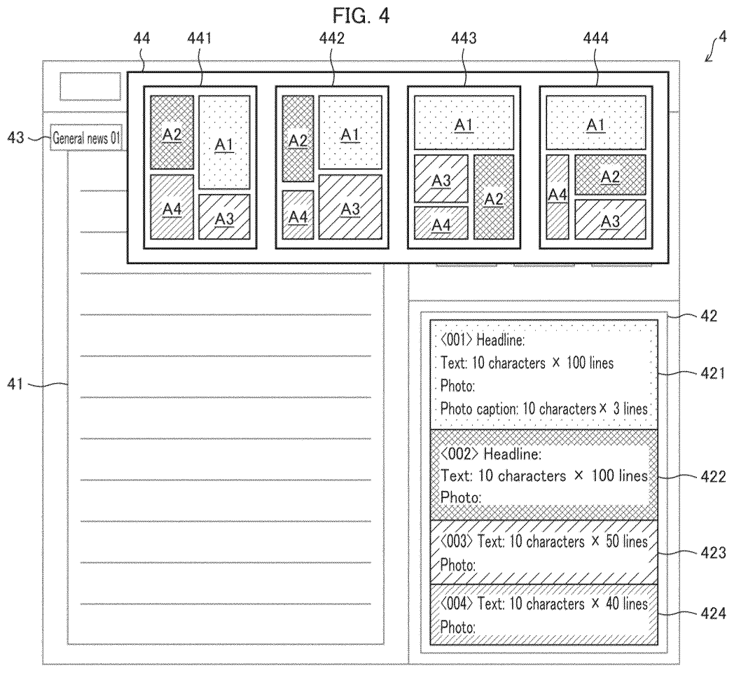

Here is a description of a configuration of an information processing apparatus 2 in accordance with the present example embodiment, provided with reference to FIG. 3. FIG. 3 is a block diagram illustrating a configuration of the information processing apparatus 2. The information processing apparatus 2 includes: a control section 20 that has the overall control of the sections of the information processing apparatus 2; and a storage section 21 that stores various kinds of data used by the information processing apparatus 2. The information processing apparatus 2 further includes a communication section 22 for the information processing apparatus 2 to communicate with another apparatus; an input section 23 for accepting a user's operation of input to the information processing apparatus 2; and a display section 24 which is a display on which to display an image.

Further, the control section 20 includes an accepting section (accepting means) 201, a display control section (display control means) 202, a makeup layout generating section (layout generating means) 203, a layout information generating section 204, a local layout generating section 205, and a training data collecting section (training data collecting means) 206. The storage section 21 has stored therein a makeup layout generation model (layout generation model) 211, a local layout generation model 212, training data 213, and article data 214. Note that the training data 213 is not originally stored, but is generated by the training data collecting section 206 and then stored in the storage section 21. The training data collecting section 206 and the training data 213 will be described in the section “Collection of training data” (described later).

Like the accepting section 12 in the first example embodiment, the accepting section 201 accepts a selection made by a user with respect to the candidates for a layout for articles. Further, the accepting section 201 accepts input of information which indicates articles to be arranged in the layout and input of various kinds of information related to the articles, and stores, in the storage section 21, the accepted information as article data 214. For example, a selection made by a user and various kinds of information may be inputted via the input section 23, or may be inputted from another apparatus via the communication section 22.

The article data 214 contains not only information which indicates articles to be arranged in a layout but also various kinds of information related to each of the articles. More specifically, the article data 214 contains information which indicates article components such as, for example, text of each article, a photo contained in each article, and the headline of each article. Further, the article data 214 may contain, as information on these components, information which indicates the content, theme, size, or volume (e.g. in a case of text, the number of letters, the number of characters per line, the number of lines, etc.) of each of the components.

The display control section 202 performs control for displaying an image on the display. This display may be the display section 24 of the information processing apparatus 2, or may be another apparatus linked to the information processing apparatus 2 by a wired or wireless connection. Like the display control section 11 in the first example embodiment, the display control section 202 displays, on the display section 24, (i) a list of articles to be arranged in a layout and (ii) pieces of layout information in each of which an arrangement of the articles in a corresponding one of candidates for the layout in which to arrange the articles is represented with use of respective shapes corresponding to the articles. In the displaying, the display control section 202 displays a shape in the layout information and an article of the list which corresponds to the shape such that the shape is associated with the article.

The makeup layout generating section 203 generates candidates for a layout in which to arrange the articles. In this respect, a layout in which to arrange articles means assigning, to each of the articles, a position and extent in which to arrange that article on a page (e.g. a page of a newspaper or a magazine, or a web page) on which to arrange the articles in the layout. Since a layout in which to arrange articles in a newspaper or the like is referred to as a makeup layout, a candidate generated by the makeup layout generating section 203 is hereinafter also referred to as a candidate for a makeup layout.

Various methods can be applied as the method for generating candidates for a makeup layout. For example, the makeup layout generating section 203 may use the makeup layout generating model 211 to generate a candidate for the makeup layout.

The makeup layout generating model 211 is a model for generating a layout in which to arrange articles, the model being generated by machine learning of relationships between explanatory variables and objective variables, the explanatory variables being various kinds of information related to the layout in which to arrange articles, the objective variable being information which indicates the layout in which to arrange the articles. The makeup layout generating model 211 may be prepared for each of the types of pages to be laid out. For example, in a case where the page to be laid out is a newspaper page, the makeup layout generation model constructed by machine learning of layouts of a general news section may be used for the generation of candidates for a layout of a general news section, and the makeup layout generation model constructed by machine learning of layouts of a society section may be used for the generation of candidates for a layout of a society section. In this manner, by preparing the makeup layout generation model for each of the types of pages to be laid out and using the makeup layout generation model according to the type of page to be laid out, to generate a candidate, it is possible to generate candidates which match the type of page to be laid out.

As the explanatory variable described above, information related to components of each article may be used. Examples of the explanatory variable may include information which indicates the size (the coordinate values of four corners or the width and height) of a page on which to arrange the article in a layout, and the contents, sizes, and volumes of text of the article, a photo contained in the article, headlines, etc. Further, information which indicates the genre and the degree of importance of the article may be included in the explanatory variable. These kinds of information regarding the article to be arranged in a layout may be contained in the article data 214. In addition, the objective variable may be information which indicates the position and extent of each of the articles in a page on which the articles are arranged in a layout. Examples of the objective variable may include (i) positional coordinates which indicate the positions of four corners of each article on the page to be laid out and (ii) representative coordinates of each article on the page to be laid out and information which indicates the width and height of the article.

The makeup layout generating model 211 may generate candidates for a makeup layout by any other methods. Examples of the other methods include a method of generating candidates in accordance with a predetermined rule such as arranging articles by degree of importance and a method of generating candidates in accordance with a user's operation. In the following description, a candidate generated with use of the makeup layout generating model 211 is referred to as an artificial intelligence (AI) candidate, and a candidate generated by any other method is referred to as other-method candidate. The AI candidate and the other-method candidate may be both generated by the makeup layout generating section 203, or may be generated separately in different processing blocks.

The layout information generating section 204 generates, for each of the candidates for a makeup layout which are generated by the makeup layout generating model 211, layout information which indicates an arrangement of the articles in that candidate with use of respective shapes corresponding to the articles. For example, the layout information generating section 204 may generate the layout information in which rectangles indicating the positions and extents of the respective articles are arranged on the rectangle indicating a page on which the articles are arranged in the layout.

The local layout generating section 205 generates a layout in which the components of an article are arranged. Since a layout in which the components of an article in a newspaper or the like is referred to as a local layout, a layout generated by the local layout generating section 205 is hereinafter also referred to as a local layout. As is the case of the candidates for a makeup layout, various methods can be applied to the local layout generation method. For example, the local layout generating section 205 may generate a local layout with use of the local layout generation model 212.

The local layout generation model 212 is a model for generating an arrangement of the components of an article, the model being generated by machine learning of relationships between explanatory variables and objective variables, the explanatory variables being various kinds of information related to the local layout of the article, the objective variable being information which indicates the arrangement of the components of the article.

As the explanatory variable described above, information related to components of each article may be used. Examples of the explanatory variable may include information which indicates the size (the coordinates of four corners or the width and height) of an article, and the contents, sizes, and volumes of text, a photo, headline, etc. contained in the article. Further, information which indicates the genre and the degree of importance of the article may be included in the explanatory variable. These kinds of information regarding the article to be arranged in a layout may be contained in the article data 214. Furthermore, the objective variable may be information which indicates the position and extent of each of the components of an article, in the area in which the article is arranged in a layout. For example, the objective variable may be information which indicates positional coordinates or the like indicating the positions of four corners of each component of an article.

### (Settings of Degree of Importance and Group)

A setting of a degree of importance may be made with respect to each of the articles to be arranged in a layout. The degree of importance is information indicating the importance of an article. The degrees of importance only need to allow determination on superiority and inferiority in importance among articles. For example, the degrees of importance may be expressed by numerical values on a scale of 0 to 100 or by a plurality of stages such as A for an important article, B for an article having a medium degree of importance, and C for an article having a low degree of importance. Since it is desirable to arrange a more important article at a more conspicuous position, the degree of importance serves as a guide to determining a layout. The degree of importance of an article can translate to a degree of priority at which the article is arranged at a conspicuous position. For example, in a case of newspapers, since the degree of importance of each article is determined in an editorial meeting, a user may set the degree of importance that is determined in the editorial meeting. This enables even a person who does not participate in the editorial meeting to determine layout in accordance with the degrees of importance determined in the editorial meeting.

The degree of importance of each article is preferably capable of being freely set and changed by the user. A method of setting and changing the degree of importance is not particularly limited. For example, the display control section 202 may display, on the display section 24, a setting screen for setting the degree of importance of each of the articles to be arranged in a layout. In this case, the accepting section 201 accepts an operation of setting the degree of importance performed on the setting screen, and records the degree of importance of each article on the article data 214 in accordance with the setting operation. For example, the degree of importance can be freely set on a scale of 1 to 100, or the greatest degree of importance and the second greatest degree of importance may be displayed as “top” and “quasi-top”, respectively.

Among articles to be arranged in a layout, a plurality of articles may be allowed to be grouped. In this case, the makeup layout generating section 203 treats the grouped plurality of articles as a single article. This allows a plurality of articles related to each other to be grouped and displayed in a block of areas. Like the degree of importance, the group is preferably capable of being freely set and changed by a user. As an example of the configuration, the display control section 202 may display, on the display section 24, a list of articles, and the accepting section 201 may accept a group setting regarding the articles and record the setting on the article data 214.

### (Display Screen Example)

FIG. 4 is a diagram illustrating an example of a display screen displayed by the display control section 202 so that a user selects a layout. A display screen 4 illustrated in FIG. 4 includes a preview area 41, an article list display area 42, and a target page information display area 43. Further, a layout selection screen 44 is displayed so as to be superimposed on a part of the preview area 41.

The preview area 41 is an area for displaying a layout result. In the preview area 41, a preview image is displayed in which each article is arranged in the layout of a candidate selected by a user. At a stage before the completion of the layout, the preview area 41 may be left blank, as illustrated in FIG. 4.

The article list display area 42 is an area for displaying a list of articles to be arranged in a layout. In the article list display area 42 of FIG. 4, a list of four articles is created. These articles are the articles to be arranged in a layout.

As information on the article to be arranged in a layout, information which indicates the components of the article is described in each of areas 421 to 424 within the article list display area 42. For example, in the area 421, the components of the article of an article identification (ID) <001> are listed. Specifically, a headline, text, a photo, and a photo caption are displayed as the components. Regarding the text, the volume thereof (more specifically, the number of characters per line and the number of lines) is also displayed.

The article list display area 42 only needs to have displayed therein information informative enough for a user to recognize what the articles to be arranged in a layout are, and the information to be displayed is not limited to that illustrated in FIG. 4. Further, identification information (e.g., article ID, headline, etc.) of an article may be listed in the article list display area 42 so that the details of the article can be viewed by selecting the identification information. For example, when one of pieces of identification information of articles displayed in the article list display area 42 is designated, the display control section 202 may display a pop-up showing the detailed information (e.g., the components of the article) of the article corresponding to the designated identification information.

The target page information display area 43 is an area for displaying target page information, which is information regarding a page on which articles are arranged in a layout. Displayed in the target page information display area 43 of FIG. 4 is target page information which indicates that the page on which the articles are arranged in a layout is a general news section (front page) of a newspaper. Thus, the target page information may indicate the type of page to be laid out. Note that the target page information only needs to be information regarding a page on which articles are arranged in a layout, and is not limited to the example of FIG. 4.

In this manner, the display control section 202 may display, together with layout information and a list of articles, target page information regarding a page on which the articles are arranged in a layout. This provides, in addition to the example embodiment produced by the information processing apparatus 1 in accordance with the first example embodiment, an example advantage of being capable of using the target page information as a guide to selecting a layout.

The layout selection screen 44 is a screen for a user to select a layout. In the layout selection screen 44, pieces of layout information are displayed in each of which an arrangement of the articles in a corresponding one of candidates for the layout in which to arrange the articles is represented with use of respective shapes corresponding to the articles. Displayed on the layout selection screen 44 of FIG. 4 are four pieces of layout information (layout information 441 to 444).

More specifically, in the layout information 441 to 444, a layout in which to arrange articles of article IDs <001> to <004> is represented with use of respective rectangles Al to A4 which correspond to these articles. For example, in the layout information 441 and 442, rectangles A1, A2, A3, and A4 are arranged respectively in the upper right part, the upper left part, the lower right part, and the lower left part in the rectangle representing a page to be laid out. This arrangement indicates that the article of article ID <001> is arranged in the upper right part, the article of article ID <002 > is arranged in the upper left part, the article of article ID <003> is arranged in the lower right part, and the article of article ID <004> is arranged in the lower left part, in a page to be laid out.

On each of the rectangles A1 to A4, a pattern corresponding to the article of that rectangle is marked. Specifically, the rectangles A1, A2, A, and A4 have marked thereon a dot pattern, a mesh pattern, a hatched pattern with wide intervals, and a hatched pattern with narrow intervals. Further, the area 421 in the article list display area 42 has a dot pattern marked thereon, as the rectangle A1 does. Similarly, the areas 422, 423, and 424 have marked thereon the same patterns as do the rectangles A2, A3, and A4, respectively.

In this manner, the display control section 202 may display at least some of the shapes in the layout information and at least some of the articles in the list which correspond to the at least some of the shapes, in the same display manners, to associate the at least some of the shapes with the at least some of the articles. With this configuration, a correspondence relationship between a shape in the layout information and an article in the list is indicated by a display manner. This provides, in addition to the example advantage produced by the information processing apparatus 1 in accordance with the first example embodiment, an example advantage of making it possible for a user to recognize the correspondence relationship between the shapes and the articles with the user's intuition and with ease.

Although the commonality of display manners is achieved by marking the same pattern in FIG. 4, patterns only need to allow a user to recognize the correspondence relationship, and do not need to be exactly the same. Further, instead of or in addition to providing the commonality of patterns, the commonality of background colors and/or display colors of frames, characters, etc. may be provided. Also in this case, the display colors only need to allow a user to recognize the correspondence relationship, and do not need to be exactly the same.

As described above, a plurality of articles may be grouped as a single group. In this case, since the grouped articles are treated as a single article, a set group is assigned a single shape in the layout information. Further, in the list of articles, the grouped articles are displayed collectively. As a matter of course, also in this case, a shape corresponding to a certain group in the layout information is displayed so as to be associated with a group of articles in the list which corresponds to the shape.

The pieces of layout information 441 to 444 also function as options regarding a selection made by a user from among the layout candidates indicated by the pieces of layout information 441 to 444. Specifically, the accepting section 201 accepts a user's selection with respect to the pieces of layout information 441 to 444, and a selected one of the pieces of layout information 441 to 444 is judged to be the candidate adopted by the user. As a matter of course, the layout candidate selection method is not limited to this example, but is any method.

### (Layout Selection Screen Regarding Candidates Generated by Plurality of Methods)

The makeup layout generating section 203 may generate some of layout candidates with use of the makeup layout generating model 211, and generate the others with use of any other method(s). By presenting candidates generated by a plurality of methods, it is possible to increase the possibility of making it possible to present a candidate which finds favor with a user.

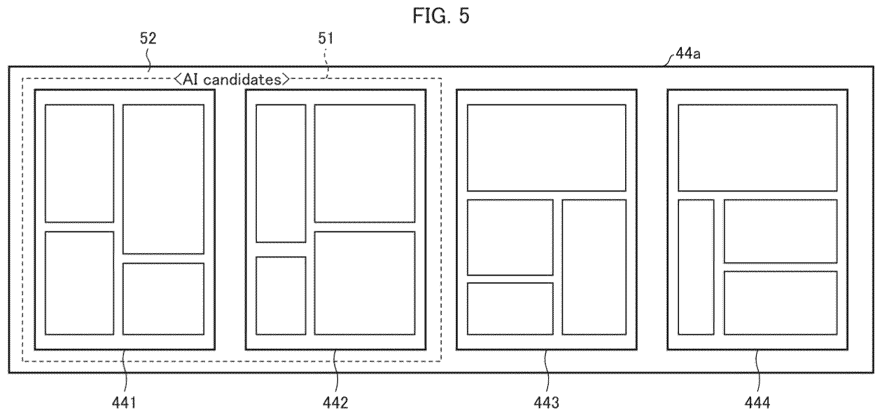

Further, in a case where the presented candidates are mixed candidates generated by differing methods, the display control section 202 may display pieces of layout information regarding the respective candidates in a generation method-dependent display manner. This will be described on the basis of FIG. 5. FIG. 5 is a diagram illustrating an example of the layout selection screen regarding candidates generated by a plurality of methods. As in the layout selection screen 44 of FIG. 4, four pieces of layout information 441 to 444 are displayed in a layout selection screen 44a illustrated in FIG. 5. A difference from the layout selection screen 44 of FIG. 4 is that with respect to the pieces of layout information 441 and 442, a dashed line frame 51 and a character string 52 are displayed for indicating that these pieces layout information are AI candidates. This makes it possible for a user to easily recognize that the pieces of layout information 441 and 442 are AI candidates and the pieces of layout information 443 and 444 are other-method candidates.

In this manner, in a case where candidates presented to a user are mixed candidates generated by differing methods, the display control section 202 may display pieces of layout information regarding the respective candidates in a generation method-dependent display manner. This provides, in addition to the example advantage produced by the information processing apparatus 1 in accordance with the first example embodiment, an example advantage of allowing a user to recognize a difference between generation methods, to select a candidate.

It should be noted that the generation method-dependent display manner only needs to allow a user to recognize, from the display manner, that the generation methods differ at least between the candidates. As an example, the character string 52, which explicitly indicates the generation method, may be omitted in FIG. 5. As another example, by, for example, assigning, to candidates generated by the same generation method, the same background color and background pattern or background colors and background patterns which correspond to each other, the difference between methods for generating the candidates may be indicated.

### (Collection of Training Data)

Here is a description of collection of the training data 213 carried out by the training data collecting section 206. As described above, the layout candidates presented to a user may include AI candidates generated with use of the makeup layout generating model 211. In this case, the training data collecting section 206 identifies the layout of an AI candidate which is included in the AI candidates generated and which is selected by a user, i.e. the AI candidate a user has decided to adopt. Further, the accepting section 201 may accept input of whether each of the AI candidates is suitable. In this case, the training data collecting section 206 identifies the layout of an AI candidate the suitability of which is inputted.

Subsequently, the training data collecting section 206 generates the training data 213 such that information indicating the layout of an AI candidate selected by the user is associated with various kinds of information on the articles in the AI candidate. The training data collecting section 206 then stores, in the storage section 21, the training data 213 generated.

The information indicating the layout of the AI candidate and the various kinds of information on the articles in the AI candidate in the training data 213 correspond respectively to the objective variable and explanatory variable in the makeup layout generating model 211. For example, in a case where the objective variables in the makeup layout generating model 211 are the coordinate values of the four corners of each article, the training data collecting section 206 generates the training data 213 such that the coordinate values of the four corners of each article in the AI candidate selected by the user are associated with the respective explanatory variables inputted to the makeup layout generating model 211 at the time of generating the AI candidate.

As above, the training data collecting section 206 store, in the storage section 21, the layout of an AI candidate selected by a user from among the AI candidates, as retraining data for the makeup layout generating model 211. This configuration provides, in addition to the example advantage of the information processing apparatus 1 in accordance with the first example embodiment, an example advantage of being capable of automatically accumulating training data 213. This training data 213 can be used as the retraining data for the makeup layout generating model 211.

For example, the training data collecting section 206 may send the training data 213 and the current makeup layout generating model 211 to a training apparatus for retraining the makeup layout generating model 211, and acquire, from the training apparatus, the makeup layout generating model 211 after the retraining. Further, the information processing apparatus 2 may include a training section for retraining the makeup layout generating model 211 with use of the training data 213. In this case, it is possible to use the information processing apparatus 2 alone, to retrain the makeup layout generating model 211.

### (Display of Result of Local Layout)

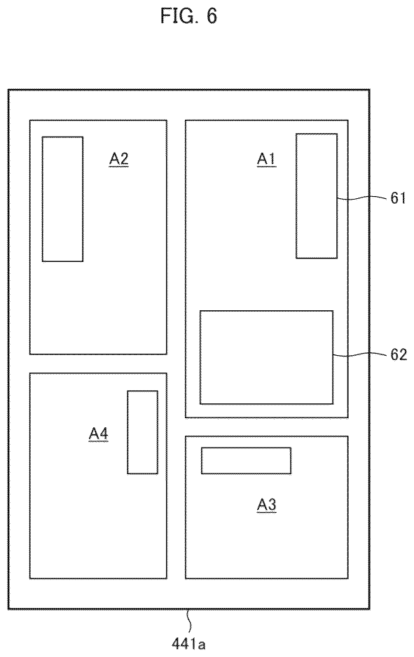

The local layout generating section 205 may perform local layout of each article (i.e. the arrangement of the components thereof in the layout) with respect to the layout candidates generated by the makeup layout generating section 203. In this case, the display control section 202 may display the layout information which contains information indicating a result of a local layout. This will be described on the basis of FIG. 6. FIG. 6 is a diagram illustrating an example of layout information which contains information indicating a result of a local layout.

A layout information 441a illustrated in FIG. 6 contains respective rectangles A1 to A4 which correspond to four articles. Further, inside each of the rectangles A1 to A4, a result of a local layout, i.e. information which indicates the arrangement of the components of the corresponding article in the display area of the article, is displayed. For example, inside the rectangle A1, a rectangle 61 indicating the position and extent of the headline of the article and a rectangle 62 indicating the position and extent of a photo of the article are displayed.

The positions and extents of the rectangles 61 and 62 in the rectangle Al are determined on the basis of the result of local layout determination processing carried out by the local layout generating section 205. Specifically, the local layout generating section 205 uses the local layout generation model 212 to determine the positions and extents of the respective components of the article which corresponds to the rectangle A1, in the display area of the size of the rectangle A1. The layout information generating section 204 then determines the position and extent of the rectangle 61 in accordance with the positions and extents determined. In addition, the layout information generating section 204 performs the same processing on the rectangles A2 to A4, and generates the layout information 441a as illustrated in FIG. 6, accordingly. The display control section 202 displays, on the display section 24, the layout information 441a thus generated.

### (Display of Degree of Importance of Article)

The display control section 202 may display importance information which indicates the degree of importance of each article. This provides, in addition to the example embodiment produced by the information processing apparatus 1 in accordance with the first example embodiment, an example advantage of making it possible for a user to easily recognize the degree of importance of each article. It is possible for the user to then consider the degree of importance to select a layout.

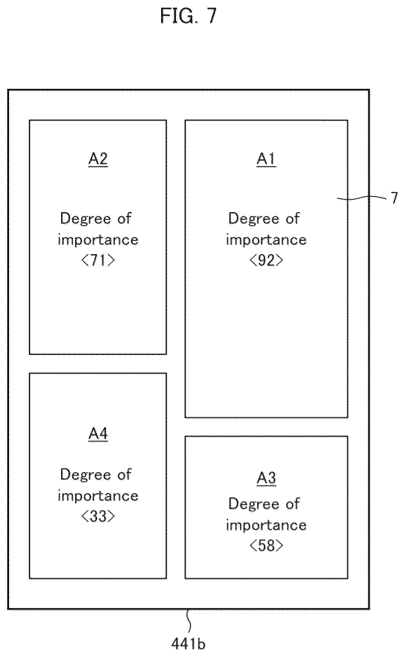

For example, the display control section 202 may display the layout information which contains importance information. This will be described on the basis of FIG. 7. FIG. 7 is a diagram illustrating layout information which contains importance information. Layout information 441b illustrated in FIG. 7 contains rectangles A1 to A4. As described above, each of the rectangles A1 to A4 indicates the position and extent of the corresponding article.

Each of the rectangles A1 to A4 of the layout information 441b contains importance information which indicates the degree of importance of an article corresponding to that rectangle. For example, the importance information 7 in the rectangle A1 indicates, by the numerical value and the character string, that the degree of importance of an article corresponding to the rectangle A1 is 92. In this manner, the layout information 441b containing the importance information 7 enables a user to recognize at a glance, for example, whether the layout makes an article of a higher degree of importance more conspicuous. This makes it possible to effectively assist layout selection.

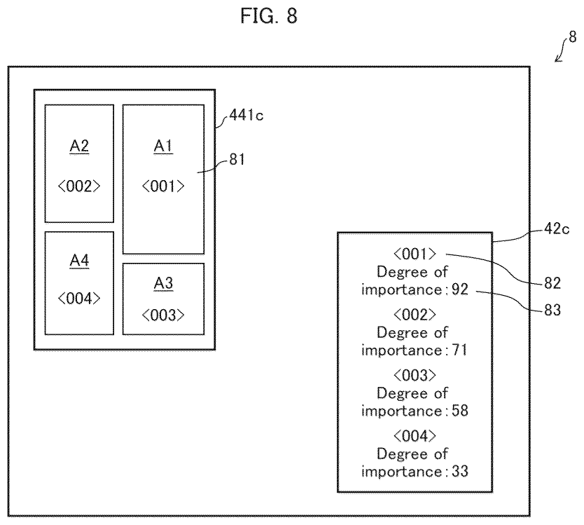

As another example, importance information may be included in the list of articles. This will be described on the basis of FIG. 8. FIG. 8 is a diagram illustrating an example of a display screen on which degrees of importance are indicated in the list of articles. Displayed on a display screen 8 illustrated in FIG. 8 are an article list display area 42c and layout information 441c. Note that the preview area 41 and the target page information display area 43 may also be displayed, as in FIG. 4. Although the single piece of layout information 441c alone is indicated in FIG. 8, the layout selection screen which contains a plurality of pieces of layout information is typically displayed.

The layout information 441c contains rectangles A1 to A4. Each of the rectangles A1 to A4 indicates the position and extent of the corresponding article. Inside each of the rectangles A1 to A4, identification information regarding the corresponding article is displayed. For example, identification information 81 displayed in the rectangle A1 indicates that the article ID of the article corresponding to the rectangle A1 is <001>.

In the article list display area 42c, not only the identification information regarding articles to be arranged in a layout is displayed as information related to the articles, but the degrees of importance of the articles are also displayed in association with the pieces of identification information regarding the articles. For example, identification information 82 indicated in the article list display area 42c indicates that the article ID thereof is <001>. In association with this identification information 82, importance information 83 is displayed which indicates that the degree of importance of the article identified by the identification information 82 is 92. Note that in addition to the above information, various kinds of information may be displayed in the article list display area 42c, the various kinds of information serving as guides to selecting a layout, such as the components of an article and the volumes of the components.

As described above, in the example of FIG. 8, the rectangles A1 to A4 in the layout information 441c and the articles of the list which correspond to the rectangles A1 to A4 are associated with each other via the pieces of identification information (specifically, the article IDs) displayed in the rectangles A1 to A4 and in the article list display area 42c. Thus, displaying the identification information regarding an article makes it possible to indicate the correspondence relationship between a shape in the layout information and an article in the list which corresponds to the shape.

As a matter of course, various display manners other than displaying the same article ID makes it possible to indicate the correspondence relationship. For example, when a cursor for selecting layout information is located on one of the shapes contained the layout information or when the shape is clicked or tapped, the display control section 202 may highlight an article in the list which corresponds to the shape. The highlighting means displaying a target article in a manner that allows discrimination between the target article and any other articles. Specific example of the highlighting include making the background color of a target article (i.e. the article corresponding to a shape on which a cursor is put) different from those of other articles, displaying the target article such that the target article pops up, and displaying an image (e.g., a line) across the space between the target article and the shape on which the cursor is put, the image indicating the correspondence relationship between the article and the shape.

As described above, in the example of FIG. 8, the rectangles A1 to A4 in the layout information 441c are associated with the articles in the list which correspond to the rectangles A1 to A4, and the importance information regarding each of the articles is indicated in the list. Such a display manner enables a user to recognize at a glance, for example, whether the layout makes an article of a higher degree of importance more conspicuous. This makes it possible to effectively assist layout selection.

### (Flow of Layout Assistance Method)

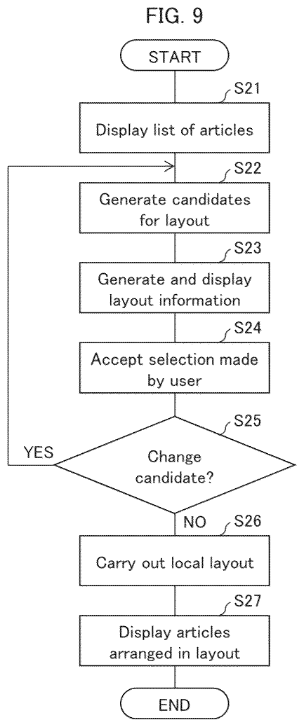

Here is a flow of a layout assistance method in accordance with the present example embodiment, provided with reference to FIG. 9. FIG. 9 is a flowchart illustrating a flow of the layout assistance method. Illustrated in FIG. 9 are processes to be carried out after the end of the settings of a degree of importance and a group.

In S21, the display control section 202 displays, on the display section 24, a list of articles on the basis of the article data 215 stored in the storage section 21. For example, the display control section 202 may display, for each of the articles to be arranged in a layout, information which indicates the components of that article, in the article list display area 42 as illustrated in FIG. 4. Further, the display control section 202 may display the importance information 83 in the article list display area 42, as in the example of FIG. 8, for example.

In S22, the makeup layout generating section 203 generates candidates for a layout. Specifically, the makeup layout generating section 203 inputs, to the makeup layout generating model 211, various kinds of information related to each of the articles to be arranged in the layout. The makeup layout generating section 203 then generates candidates (the above-described AI candidates) for the layout in which to arrange the articles, on the basis of values outputted from the makeup layout generating model 211. Further, the makeup layout generating section 203 may generate the above-described other-method candidates in addition to the AI candidates.

In S23, the layout information generating section 204 generates, for each of the candidates generated in S22, layout information in which an arrangement of the articles in that candidate is represented with use of respective shapes corresponding to the articles. The display control section 202 then displays the layout information generated on the display section 24. In the displaying, the display control section 202 displays a shape in the layout information and an article of the list which corresponds to the shape such that the shape is associated with the article.

Note that the display screen on which a shape in the layout information is associated with an article in the list which corresponds to the shape may be generated by the layout information generating section 204, or may be generated by the display control section 202. Further, as described above, when an operation (e.g., putting a cursor on a shape) of designating a shape in the layout information is performed, an article in the list which corresponds to the shape may be highlighted. In this case, the display control section 202 may perform the highlighting, when the above operation of designating a shape is performed, and the display of association is not necessary in S23.

In S23, in a case where candidates in each of which to display the layout information are mixed candidates generated by differing methods, the display control section 202 may display pieces of layout information regarding the respective candidates in a generation method-dependent display manner, as in the example of FIG. 5, for example. As another example, the display control section 202 may display target page information regarding a page on which to arrange the articles of FIG. 4 (see the target page information display area 43 in FIG. 4).

As another example, the display control section 202 may display information which indicates an arrangement of the components of an article, as in the example of FIG. 6. In this case, before the process of S23, the local layout generating section 205 carries out a local layout for each of the candidates generated in S22. As still another example, the display control section 202 may display layout information which contains importance information, as in the example of FIG. 7.

In S24, the accepting section 201 accepts a selection made by a user with respect to the layout candidates. For example, the accepting section 201 may accept a selection operation such as clicking or tapping one of the pieces of layout information displayed in S23.

In S25, the accepting section 201 judges whether an operation of changing the candidate is performed. In a case where the operation of changing the candidate is judged to be performed (YES in S25), the method returns to the process of S22. In a case where the operation of changing the candidate is not judged to be performed (NO in S25), the method proceeds to the process of S26. Note that in a case where after the display of the layout information, an operation of selecting the candidate is not detected within a predetermined period of time in S25, the accepting section 201 may judge that the operation of changing the candidate has been performed.

In a case where the method returns to S22 from S25, the makeup layout generating section 203 generates a new candidate. The new candidate only needs to be different from the candidates previously generated, and a method of generating the new candidate is not particularly limited. For example, a plurality of makeup layout generating models 211 may be prepared in advance. In this case, the makeup layout generating section 203 may generate the new candidate with use of the makeup layout generating model 211 which is not the makeup layout generating model 211 previously used. As another example, in a case where the candidates previously generated are AI candidates, other-method candidates may be generated. As still another example, the makeup layout generating section 203 may generate a new candidate in accordance with a user's input operation.

As described above, in a case where no selection is made with respect to the candidates displayed by the display control section 202, the makeup layout generating section 203 may generate a new layout candidate indicating an arrangement of articles which is different from those indicated by the candidates previously displayed. This provides, in addition to the example advantage produced by the information processing apparatus 1 in accordance with the first example embodiment, an example advantage of making it possible to provide a layout conforming with the intention of a user even in a case where among the previously displayed candidates, there is not a candidate which conforms with the intention of a user.

As with the case of the previous candidates, layout information of the new candidate is also generated in S23. At the time of displaying the layout information regarding the new candidate, the display of the pieces of layout information regarding the previous candidates may be ended, or may be continued. In a case where the display of the pieces of layout information regarding the previous candidates is continued, the display control section 202 preferably displays the previous candidates and the new candidate in a manner that allows discrimination therebetween.

Further, instead of generating a new candidate, the accepting section 201 may accept a user's modification to an existing candidate. This process only needs to be carried out after S23, and after this process is ended, the process of S26 and the subsequent processes are carried out on the basis of the candidate after the modification. A manner in which the modification is accepted is not particularly limited. For example, the accepting section 201 may accept an operation of changing the position and extent of a shape corresponding to each of the articles contained in the layout information.

In S26, the local layout generating section 205 carries out a local layout of an article judged to be selected in S24. Specifically, the local layout generating section 205 inputs, to the local layout generation model 212, the size of the article to be indicated in the makeup layout selected in S24 and various kinds of information on the components of the article. The local layout generating section 205 then determines an arrangement of the components of the article, on the basis of the values outputted from the local layout generation model 212. This process is carried out with respect to each of the articles to be indicated in the makeup layout selected in S24. Note that as described above, the local layout may be performed before S23. In this case, S26 is omitted.

In S27, the display control section 202 displays the components of each of the articles in the arrangement determined in S26. That is, the display control section 202 displays the components of each of the articles in accordance with the makeup layout selected in S24 and the local layout determined in S26. For example, the display control section 202 may display the components of each of the articles in the preview area 41 illustrated in FIG. 4. With this, the process of FIG. 9 ends.

In a case where the layout displayed in S27 does not conform with the intention of a user, starting from the process of S22 or S26, the processes may be carried out again in accordance with the user's input operation. The process of S27 is not essential. For example, upon the end of the makeup and local layouts, these layouts are stored in the storage section 21 or the like, and the process may be ended.

### (Display of Candidates for Local Layout)

The local layout generating section 205 may generate a plurality of candidates for a local layout in the same manner as the makeup layout generating section 203 generates a plurality of candidates for a makeup layout. In this case, the display control section 202 may display, on the display section 24, the generated candidates for the local layout, and the accepting section 201 may accept a user's selection with respect to the candidates displayed.

In this case, the layout information generating section 204 may generate layout information for a candidate for the local layout in the same manner in which the layout information is generated regarding the makeup layout. In the layout information regarding a candidate for the local layout, the arrangement of the components of the article of each candidate may be represented with use of respective shapes corresponding to the components.

Further, in this case, the display control section 202 may display a shape in the layout information regarding a candidate for the local layout and a component in a list which corresponds to the shape, such that the shape is associated with the component. As the association manner, various manners can be used, as is the case of the association of an article in the makeup layout information.

Further, the display control section 202 may display, in a shape in the layout information regarding a local layout candidate, identification information regarding a component (e.g. the name of the component such as “headline”, “text”, or “photo”).

### Variation

A performer which carries out each of the processes described in the example embodiments above is any performer, and is not limited to the above examples. In other words, it is possible to construct a layout assistance system having the same functions as those of the information processing apparatuses 1 and 2 with use of a plurality of apparatuses capable of conducting communication with each other. For example, it is possible to construct an assistance system having the same functions as those of the information processing apparatus 2, by dispersedly providing, in a plurality of apparatuses, respective blocks illustrated in FIG. 3.

For example, among the processing blocks included in the control section 20 illustrated in FIG. 3, all the processing blocks except the accepting section 201 and the display control section 202 may be provided in a cloud server. In this case, the information processing apparatus 2 sends, to the cloud server, the article data 214 or various kinds of data on which the article data 214 is based, so that candidates for a layout and pieces of layout information corresponding to the candidates are generated. The information processing apparatus 2 may then acquire, from the cloud server, the pieces of layout information generated to display the layout information. As another example, the cloud server may generate the display screen as in FIG. 4, the display screen displaying a shape in the layout information and an article in the list which corresponds to the shape such that the shape and the article are associated with each other. In this case, the information processing apparatus 2 may acquire, from the cloud server, various kinds of data necessary for displaying the display screen generated. With such a configuration, it is possible to easily select a candidate from among the candidates for a layout, the candidate conforming with the intention of a user.

It is also possible to construct an assistance system which includes: a layout generation apparatus including the functions of the makeup layout generating section 203; and an assistance apparatus for displaying layout candidates generated by the layout generation apparatus in a manner described in the example embodiments above and accepting a user's selection of a candidate. Like the information processing apparatus 2, this assistance system makes it possible to easily select a candidate from among layout candidates, the candidate conforming with the intention of a user.

### Software Implementation Example

Some or all of the functions of each of the information processing apparatuses 1 and 2 may be implemented by hardware such as an integrated circuit (IC chip), or may be implemented by software.

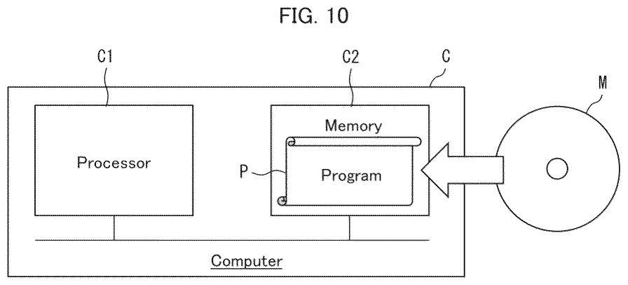

In the latter case, the information processing apparatuses 1 and 2 are provided by, for example, a computer that executes instructions of a program that is software implementing the foregoing functions. An example (hereinafter, computer C) of such a computer is illustrated in FIG. 10. The computer C includes at least one processor C1 and at least one memory C2. The memory C2 has recorded thereon a program P (layout assistance program) for causing the computer C to operate as the information processing apparatus 1 or 2. The processor C1 of the computer C retrieves the program P from the memory C2 and executes the program P, so that the functions of the information processing apparatus 1 or 2 are implemented.

Examples of the at least one processor Cl can include a central processing unit (CPU), a graphic processing unit (GPU), a digital signal processor (DSP), a micro processing unit (MPU), a floating point number processing unit (FPU), a physics processing unit (PPU), a microcontroller, and a combination thereof. Examples of the memory C2 can include a flash memory, a hard disk drive (HDD), a solid state drive (SSD), and a combination thereof.

The computer C may further include a random access memory (RAM) into which the program P is loaded at the time of execution and in which various kinds of data are temporarily stored. The computer C may further include a communication interface via which data is transmitted to and received from another apparatus. The computer C may further include an input-output interface via which input-output equipment such as a keyboard, a mouse, a display or a printer is connected.

The program P can be recorded on a non-transitory, tangible recording medium M capable of being read by the computer C. Examples of such a recording medium M can include a tape, a disk, a card, a semiconductor memory, and a programmable logic circuit. The computer C can obtain the program P via such a recording medium M. The program P can be transmitted via a transmission medium. Examples of such a transmission medium can include a communication network and a broadcast wave. The computer C can also obtain the program P via such a transmission medium.

### Additional Remark 1

The present invention is not limited to the above example embodiments, but may be altered in various ways by a skilled person within the scope of the claims. For example, the present invention also encompasses, in its technical scope, any example embodiment derived by appropriately combining technical means disclosed in the above example embodiments.

### Additional Remark 2

The whole or part of the example embodiments disclosed above can be described as, but not limited to, the following supplementary notes.

### (Supplementary Note 1)

An information processing apparatus including: a display control means for displaying, on a display, (i) a list of articles to be arranged in a layout and (ii) pieces of layout information in each of which an arrangement of the articles in a corresponding one of candidates for the layout in which to arrange the articles is represented with use of respective shapes corresponding to the articles, the list and the pieces of layout information being displayed such that each of the shapes in the pieces of layout information is associated with an article in the list which corresponds to that shape; and an accepting means for accepting a selection made by a user with respect to the candidates.

### (Supplementary Note 2)

The information processing apparatus described in supplementary note 1, in which the display control means is configured to associate at least some of the shapes in the pieces of layout information with at least some of the articles in the list which correspond to the at least some of the shapes, by using the same color or colors which correspond to each other to display the at least some of the shapes and at least some of the articles.

### (Supplementary Note 3)

The information processing apparatus described in supplementary note 1 or 2, in which the display control means is configured to display importance information which indicates a degree of importance of each of the articles.

(Supplementary note 4)

The information processing apparatus described in any one of supplementary notes 1 to 3, further including a layout generating means for generating a new candidate for the layout, the new candidate being different in an arrangement of the articles from each of the candidates previously displayed, in a case where no selection is made with respect to the candidates displayed by the display control means.

### (Supplementary Note 5)

The information processing apparatus described in any one of supplementary notes 1 to 4, in which the candidates are mixed candidates generated by differing methods, and the display control means is configured to display the pieces of layout information regarding the respective candidates in a generation method-dependent display manner.

### (Supplementary Note 6)

The information processing apparatus described in any one of supplementary notes 1 to 5, in which the candidates includes AI candidates generated by a layout generation model constructed through machine learning of arrangements of articles, and the information processing apparatus further includes a training data collecting means for storing, in storage, a layout of an AI candidate selected by a user from among the AI candidates, as retraining data for the layout generation model.

### (Supplementary Note 7)

The information processing apparatus described in any one of supplementary notes 1 to 6, in which the display control means is configured to display target page information regarding a page on which the articles are arranged, together with the pieces of layout information and the list.

### (Supplementary Note 8)

A layout assistance method including: at least one processor displaying, on a display, (i) a list of articles to be arranged in a layout and (ii) pieces of layout information in each of which an arrangement of the articles in a corresponding one of candidates for the layout in which to arrange the articles is represented with use of respective shapes corresponding to the articles, the list and the pieces of layout information being displayed such that each of the shapes in the pieces of layout information is associated with an article in the list which corresponds to that shape; and the at least one processor accepting a selection made by a user with respect to the candidates.

### (Supplementary Note 9)

A layout assistance program for causing a computer to function as: a display control means for displaying, on a display, (i) a list of articles to be arranged in a layout and (ii) pieces of layout information in each of which an arrangement of the articles in a corresponding one of candidates for the layout in which to arrange the articles is represented with use of respective shapes corresponding to the articles, the list and the pieces of layout information being displayed such that each of the shapes in the pieces of layout information is associated with an article in the list which corresponds to that shape; and an accepting means for accepting a selection made by a user with respect to the candidates.

### Additional Remark 3

Furthermore, some of or all of the above example embodiments can also be expressed as follows. An information processing apparatus including at least one processor, the at least one processor carrying out: a process of displaying, on a display, (i) a list of articles to be arranged in a layout and (ii) pieces of layout information in each of which an arrangement of the articles in a corresponding one of candidates for the layout in which to arrange the articles is represented with use of respective shapes corresponding to the articles, the list and the pieces of layout information being displayed such that each of the shapes in the pieces of layout information is associated with an article in the list which corresponds to that shape; and a process of accepting a selection made by a user with respect to the candidates.

This information processing apparatus may further include a memory, and this memory may have stored therein a program for causing the at least one processor to carry out the process of displaying the list and the layout information and the process of accepting a selection made by a user. This program may be stored in a computer-readable, non-transitory, and tangible recording medium.

### REFERENCE SIGNS LIST

1: Information processing apparatus
11: Display control section (display control means)
12: Accepting section (accepting means)
2: Information processing apparatus
201: Accepting section (accepting means)
202: display control section (display control means)
203: Makeup layout generating section (layout generating means)
206: Training data collecting section (training data collecting means)
211: Makeup layout generation model (layout generation model)

What is claimed is:

1. An information processing apparatus comprising
at least one processor, the at least one processor carrying out:
a display control process of displaying, on a display, (i) a list of articles to be arranged in a layout and (ii) pieces of layout information in each of which an arrangement of the articles in a corresponding one of candidates for the layout in which to arrange the articles is represented with use of respective shapes corresponding to the articles, wherein the list and the pieces of layout information are displayed such that each of the shapes in the pieces of layout information is associated with an article in the list which corresponds to that shape; and
an accepting process of accepting a selection made by a user with respect to the candidates.

2. The information processing apparatus according to claim 1, wherein
in the display control process, the at least one processor associates at least some of the shapes in the pieces of layout information with at least some of the articles in the list which correspond to the at least some of the shapes, by using the same color or colors which correspond to each other to display the at least some of the shapes and at least some of the articles.

3. The information processing apparatus according to claim 1, wherein
in the display control process, the at least one processor displays importance information which indicates a degree of importance of each of the articles.

4. The information processing apparatus according to claim 1, wherein
the at least one processor further carries out a layout generating process of generating a new candidate for the layout, the new candidate being different in an arrangement of the articles from each of the candidates previously displayed, in a case where no selection is made with respect to the candidates displayed by the display control process.

5. The information processing apparatus according to claim 1, wherein
the candidates are mixed candidates generated by differing methods, and
in the display control process, the at least one processor displays the pieces of layout information regarding the respective candidates in a generation method-dependent display manner.

6. The information processing apparatus according to claim 1, wherein
the candidates includes A1 candidates generated by a layout generation model constructed through machine learning of arrangements of articles, and
the information processing apparatus at least one processor further-comprises carries out a training data collecting means for process of storing, in storage, a layout of an A1 candidate selected by a user from among the AI candidates, as retraining data for the layout generation model.

7. The information processing apparatus according to claim 1, wherein
in the display control process, the at least one processor displays target page information regarding a page on which the articles are arranged, together with the pieces of layout information and the list.

8. A layout assistance method comprising:
at least one processor displaying, on a display, (i) a list of articles to be arranged in a layout and (ii) pieces of layout information in each of which an arrangement of the articles in a corresponding one of candidates for the layout in which to arrange the articles is represented with use of respective shapes corresponding to the articles, wherein the list and the pieces of layout information are displayed such that each of the shapes in the pieces of layout information is associated with an article in the list which corresponds to that shape; and
the at least one processor accepting a selection made by a user with respect to the candidates.

9. A computer-readable non-transitory recording medium having recorded thereon a program for causing a computer to carry out:
a display control process of displaying, on a display, (i) a list of articles to be arranged in a layout and (ii) pieces of layout information in each of which an arrangement of the articles in a corresponding one of candidates for the layout in which to arrange the articles is represented with use of respective shapes corresponding to the articles, wherein the list and the pieces of layout information are displayed such that each of the shapes in the pieces of layout information is associated with an article in the list which corresponds to that shape; and
an accepting process of accepting a selection made by a user with respect to the candidates.
